(19) United States
(12) Patent Application Publication
(10) Pub. No.: US 2005/0198631 A1
(43) Pub. Date: Sep. 8, 2005

(54) Method, software and system for deploying, managing and restoring complex information handling systems and storage

(75) Inventors: Monte Coleman Bisher, Round Rock, TX (US); Mesfin Berhe Makonnen, San Diego, CA (US); Dwayne Joseph Rodi, Austin, TX (US); David Edward Wilcoxen JR., Austin, TX (US); Hector Manuel Valenzuela, Cedar Park, TX (US); Johnathan Chris Washington, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 10/755,791

(22) Filed: Jan. 12, 2004

(51) Int. Cl. G06F 9/445

(52) U.S. Cl. 717/178

(57) ABSTRACT

A system, method and software are provided for the automated deployment of complex server and standalone server, server-to-storage, SAN and/or standalone storage solutions. After collection of information identifying hardware to be included in a site deployment as well as a deployment design for the site, provision is made for the automated gathering of any remaining additional information required for implementation. Once all necessary information has been gathered and obtained, the system method and software of the present disclosure provide for the automated verification of availability and connectivity of deployment hardware. In addition, all necessary settings and configurations between one or more servers, switches and/or storage devices are automatically implemented. During implementation, bootable media may be automatically created as needed. Following implementation, a deployment design capture of the system may be performed and one or more reports concerning the standalone server, server-to-storage, SAN and/or standalone storage solution generated.

### TECHNICAL FIELD

The present disclosure relates generally to information handling systems and, more particularly, to automating the creation and maintenance of complex information handling system solutions.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems or components.

One area of information handling system use that continues to see growth and development is that of complex server, storage and standalone server, server-to-storage, SAN (storage area network) and/or standalone storage installations. In many instances, complex standalone server, server-to-storage, SAN and/or standalone storage installations include a plurality of servers coupled to a plurality of storage devices, typically storage area networks, through a plurality of switches. In such installations, the complexity of the numerous connections between multiple servers and storage area networks through numerous switches is often multiplied by the existence of similar numbers of secondary communication paths, creating redundancy and enhancing availability.

Today, the installation or deployment of complex standalone server, server-to-storage, SAN and/or standalone storage solutions are typically performed by the server or storage hardware provider or a third party installation service provider. Generally, in either case, the on-site personnel tasked with implementing a standalone server, server-to-storage, SAN and/or standalone storage installation or deployment must perform in accordance with voluminous instruction manuals to properly configure a requested deployment design. As a result of such labor-intensive requirements, many installations have associated with them high costs, narrow work windows and the requirement of personnel having high level of computer skills. As a further consequence of today's deployment methodologies, complex standalone server, server-to-storage, SAN and/or standalone storage installations or deployments are typically time consuming and susceptible to high rates of human error. In addition, restoration of a failed installation today may typically only be achieved by repeating the entire original implementation process.

### SUMMARY

In accordance with teachings of the present disclosure, software is provided for automating implementation of a complex information handling system (IHS) hardware deployment. In a preferred embodiment, the software is embodied in computer readable media and when executed operable to collect information identifying IHS hardware for a complex IHS hardware deployment. The software is preferably further operable to discover additional information required to implement the complex IHS hardware deployment and initiate at least one routine operable to configure the IHS hardware in accordance with the collected and discovered information such that implementation of the complex IHS hardware deployment may be effected.

Further, teachings of the present disclosure provide a method for deploying a complex IHS solution. In a preferred embodiment, the method includes gathering information identifying hardware to be included in the complex IHS solution and gathering information describing the complex IHS solution to be deployed. The method preferably also includes providing the hardware identification information and the complex IHS solution description information to at least one program of instructions. The program of instructions is preferably operable to effect realization of the complex IHS solution through the execution of steps including verifying connectivity between selected hardware, discovering hardware information required to implement the complex IHS solution and configuring selected identified hardware in accordance with the hardware identification information, the complex IHS arrangement description and the discovered information.

In addition, teachings of the present disclosure also provide an information handling system for use in deploying, managing and restoring complex hardware. In a preferred embodiment, the system includes at least one processor, memory operably associated with the processor and a program of instructions storable in the memory and executable by the processor. The program of instructions is preferably operable to receive information identifying complex hardware to be configured and a configuration description for the hardware deployment. The program of instructions is preferably further operable to obtain unique information required to implement the described hardware configuration from the hardware and execute at least one script configured to effect settings in the hardware such that the hardware configuration description may be realized.

In a first aspect, the present disclosure provides the technical advantages of enabling substantially simultaneous installation of multiple servers, internal and/or external storage devices and a complete storage area network environment while increasing deployment accuracy, reusability and recoverability.

In another aspect, the present disclosure provides the technical advantages of decreasing standalone server, server-to-storage, SAN and/or standalone storage deployment installation time, minimizing human error through the minimization of human input, and ensuring that an architected solution is quickly and efficiently delivered as designed.

In a further aspect, the present disclosure provides the technical advantage of guiding a user through the requirements necessary to automate all server, storage and storage area network, and/or external storage device configurations.

In yet another aspect, the present disclosure provides the technical advantage of reducing the time it takes to restore a failed standalone server, server-to-storage, SAN and/or standalone storage deployment through such utilities as deployment design capture and automated server, storage and storage area network configuration and connection.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram illustrating one embodiment of a system for automating the deployment, management and recovery of a complex standalone server, server-to-storage, SAN and/or standalone storage solutions, according to teachings of the present disclosure.

FIG. 2 is a block diagram illustrating one embodiment of a complex standalone server, server-to-storage, SAN and/or standalone storage or stand-alone storage solution, according to teachings of the present disclosure.

FIG. 3 is a flow diagram illustrating one embodiment of a method for automating the deployment, management and restoration of a complex standalone server, server-to-storage, SAN and/or standalone storage, according to teachings of the present disclosure; beginning with the gathering of pertinent information required to begin automation and suspending after the automation device is built and validates all gathered information.

FIG. 4 is a flow diagram illustrating one embodiment of a method for automating the deployment, management and restoration of a stand-alone server, complex standalone server, server-to-storage, SAN and/or standalone storage solution according to teachings of the present disclosure; continues with booting the system automation device and suspends with the synchronization of a complete standalone system or system ready for server-to-storage and/or SAN storage attachment.

FIG. 5 is a flow diagram illustrating one embodiment of a method for automating the deployment, management and restoration of a stand-alone server, complex standalone server, server-to-storage, SAN and/or standalone storage solution according to teachings of the present disclosure; beginning with the merger of two parallel streams of logic for the automated system device build process and paths assimilate the process for external storage.

FIG. 6 is a flow diagram illustrating one embodiment of a method for automating the deployment, management and restoration of a stand-alone server, server-to-storage, SAN and/or standalone storage solution according to teachings of the present disclosure; Beginning with the deployment of all the remaining host-bound applications required for the system's mission and ending the methodology and process with a complete electronic analysis and report generation encompassing all the previous steps, configuration, settings and errors associated.

### DETAILED DESCRIPTION

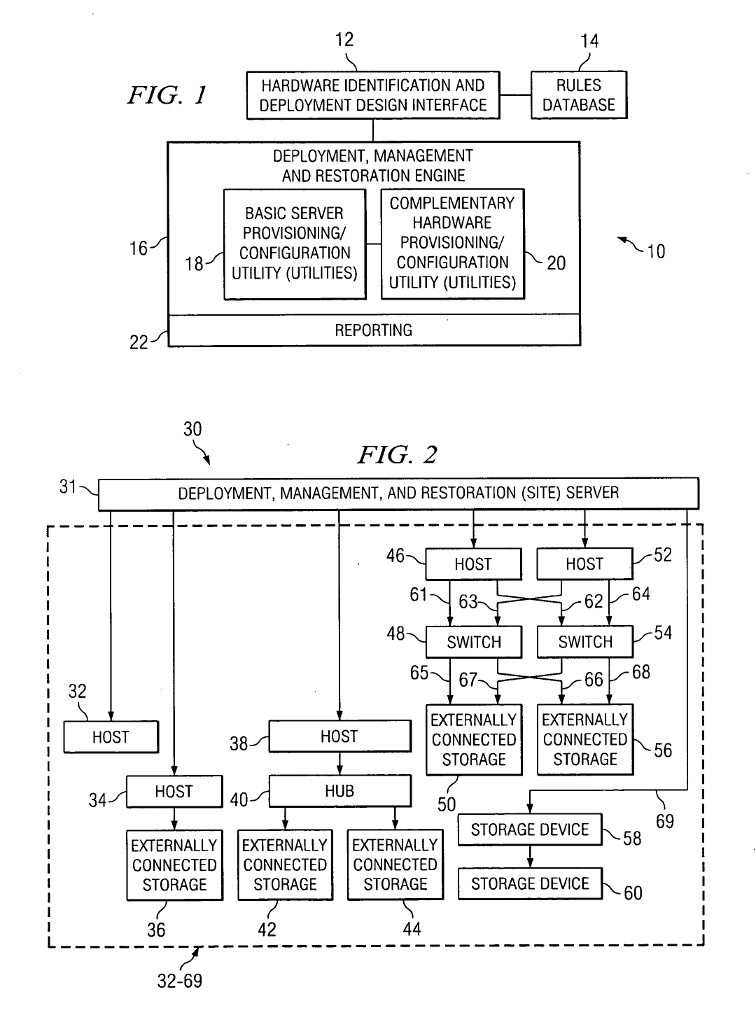

Preferred embodiments and their advantages may be best understood by reference to FIGS. 1 through 6, wherein like numbers are used to indicate like and corresponding parts.

For purposes of this disclosure, an IHS (information handling system) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk or media drives, one or more network ports for communicating with multiple external devices as well as various input and output (I/O) devices, such as a keyboard, a mouse, USB (universal serial bus) key, and a video display. The IHS may also include one or more buses, planar boards, backplanes or motherboards operable to transmit communications between the various hardware components.

Referring first to FIG. 1, a block diagram illustrating one embodiment of a system for automating the deployment, management and restoration (DMR) of complex information handling system solutions is shown, according to teachings of the present disclosure. In a preferred embodiment, system 10 may be used to deploy, manage and restore complex standalone server, server-to-storage, SAN and/or standalone storage solutions, as well as for other applications. While reference herein is made primarily to complex standalone server, server-to-storage, SAN and/or standalone storage solutions, teachings of the present disclosure may be leveraged in a variety of situations.

In one embodiment of system 10, hardware identification and deployment design interface 12 is preferably included. Hardware identification and deployment design interface 12 is preferably implemented as a graphical user interface (GUI) enabling a user to describe and/or select hardware to be employed in a networked standalone server, server-to-storage, SAN and/or standalone storage solution.

Hardware identification and deployment design interface 12 preferably enables a user to enter a personality for hardware to be included in the networked solution, to describe a storage configuration, and may permit a user to describe the physical location of various hardware components as well as cabling information between hardware components. Hardware identification and deployment design interface 12 may also be configured to elicit and receive myriad additional information concerning information handling system deployment design.

In one embodiment, a hardware personality may include a hardware device's serial number, assigned name, site code, IP (Internet Protocol) assignment table information, as well as other information. Examples of storage information which may be entered via hardware identification and deployment design interface 12 may include label, group, volume and/or logical unit number (LUN) assignments, drive assignments, device parameters, enclosure information, RAID (redundant array of independent disks) configurations, as well as myriad additional information. Examples of physical location and cabling information may include the rack number and slot identification in which a hardware component is located, cabling matrix information associated with connections between hardware components to be included in a selected standalone server, server-to-storage, SAN and/or standalone storage solution, as well as other information.

Also preferably included in automated complex standalone server, server-to-storage, SAN and/or standalone storage solution DMR system 10 is rules database 14. As illustrated, rules database 14 may be implemented separate and apart from hardware identification and deployment design interface 12. In an alternate embodiment, rules database 14 may be incorporated within hardware identification and deployment design interface 12. Alternate implementations of rules database 14 may be incorporated according to teachings of the present disclosure.

In a preferred embodiment, rules database 14 preferably interfaces with and constrains selections within hardware identification and deployment design interface 12. For example, in permitting a selection of a configuration and design via hardware identification and deployment design interface 12, rules database 14 preferably limits configuration and design selections based at least on technical constraints associated with the hardware components selected for inclusion in the site's standalone server, server-to-storage, SAN and/or standalone storage solution. More specifically, for example, rules database 14 may constrain the number of connections a user may request between a selected server and one or more storage devices based on rules reflecting the fact that the selected server includes the capability to support a limited number of communication connections, e.g., the selected server may contain two (2) host bus adapters (HBA) or only two (2) network interface cards (NIC).

In addition to limiting configuration of standalone server, server-to-storage, SAN and/or standalone storage solutions to technically feasible configurations, rules database 14 may also monitor and track label, group, volume and/or logical unit number (LUN) assignments, drive assignments, zoning assignments, or other configurations selected in designing a complex IHS solution. In general, rules database 14 preferably cooperates with hardware identification and deployment design interface 12 to ensure completion of a configuration and design for a standalone server, server-to-storage, SAN and/or standalone storage solution as well as to ensure that a designed standalone server, server-to-storage, SAN and/or standalone storage solution is feasible, i.e., the hardware selected and the arrangement desired fit within the constraints and capabilities needing to be considered for proper deployment. Such monitoring may be pursued in an effort to prevent the duplication, omission or overlapping of assignments as well as other configuration errors.

As illustrated in FIG. 1, one embodiment of an automated system for deploying, managing and restoring complex standalone server, server-to-storage, SAN and/or standalone storage solutions preferably includes deployment, management and restoration (DMR) engine 16. In one aspect, DMR engine 16 may be employed to effect or implement a site configuration and deployment chosen through the cooperation of hardware identification and deployment design interface 12 with rules database 14. Preferably using one or more basic server provisioning/configuration utilities 18 and one or more complementary hardware provisioning/configuration utilities 20, operations are required to implement or effect a selected standalone server, server-to-storage, SAN and/or standalone storage deployment may be performed.

For example, in a selected standalone server, server-to-storage, SAN and/or standalone storage solution, basic server provisioning/configuration utilities 18 may be employed to provision or configure one or more operational aspects of a server while complementary hardware provisioning/configuration utilities 20 may be employed to provision or configure additional aspects of the server to be included in the selected solution. Complementary hardware provisioning/configuration utilities 20 may also be employed to create one or more connections between a server and storage through one or more switches, create and divide areas of storage, as well as perform numerous other tasks permitting substantially unlimited complexity and flexibility in standalone server, server-to-storage, SAN and/or standalone storage deployment.

Automated standalone server, server-to-storage, SAN and/or standalone storage deployment, management and restoration system 10 preferably also includes reporting module 22. Reporting module 22 is preferably operable to perform a number of operations. In one embodiment, reporting module 22 may be employed to generate one or more reports conveying details of a deployed standalone server, server-to-storage, SAN and/or standalone storage solution. In another example, reporting module 22 may be utilized to generate one or more graphical maps depicting one or more aspects of hardware placement or cabling connections between hardware, one or more maps depicting the assignment and division of storage, as well as other reports. Additional detail regarding the operation of automated complex standalone server, server-to-storage, SAN and/or standalone storage solution deployment, management and restoration system 10 as well as its associated hardware identification and deployment design interface 12, rules database 14, DMR engine 16, basic server provisioning/configuration utilities 18, complementary hardware provisioning/configuration utilities 20 and reporting module 22 are discussed below.

Referring now to FIG. 2, a block diagram depicting one embodiment of a complex standalone server, server-to-storage, SAN and/or standalone storage solution incorporating teachings of the present disclosure is shown. According to teachings of the present disclosure, deployment, management and restoration of a complex standalone server, server-to-storage, SAN and/or standalone storage solution 30 depicted in FIG. 2, may be substantially automated upon collection of identification information for hardware as well as configuration and connection information for and between hardware devices in the solution. As mentioned above, while reference herein is made to the deployment, management and restoration of complex standalone server, server-to-storage, SAN and/or standalone storage solutions, teachings of the present disclosure may also be employed in the configuration and deployment of servers to be later coupled to one or more storage devices and vice versa.

As illustrated, FIG. 2 depicts block and file connectivity options for complex standalone server, server-to-storage, SAN and/or standalone storage solutions. Complex IHS solution 30 preferably includes one or more site servers 31, one or more systems or hosts 32, 34, 38, 46 and 52, one or more hubs 40 and switches 48 and 54, as well as a plurality of storage devices 36, 42, 44, 50, 56, 58 and 60. In an alternate embodiment, automated deployment, management and restoration of complex standalone server, server-to-storage, SAN and/or standalone storage solution capabilities may be implemented on one or more site servers 31, i.e., on a server selected to remain in a completed standalone server, server-to-storage, SAN and/or standalone storage solution as well as on a system which will not remain as a device of the desired deployment.

In the implementation of a complex server-to-storage, SAN and external storage deployment illustrated in FIG. 2, site server 31 is preferably coupled to storage devices either in a point-to-point, hub, and/or switched network manner. However, other storage topologies like bus, tree, ring, nested, star, mesh and crossbar may also be employed. In an embodiment directed to a standalone server solution, deployment, management and recovery may begin with a site server 31 and potentially numerous hosts systems 32. In an embodiment directed to a standalone storage solution, deployment, management and recovery may begin with a site server 31 and potentially numerous internal or external storage devices 58 and 60. In an embodiment directed to a server-to-storage solution, deployment, management and recovery may begin with a site server 31 and connect potentially numerous hosts systems 34 and many direct attached storage devices 36. A potential alternative to the previous server-to-storage solution may include using site server 31 to deploy, manage and recover, through hub 40, various types of hub-attached external storage devices. In yet another alternative embodiment, server-to-storage deployment, management and recovery site server 31 may deploy external SAN storage 50 and 56 through switches 48 and 54.

As illustrated in FIG. 2, site server 31 is preferably coupled to storage device 50 through switch 48 via cable connections or communication paths 65 and 67. In part for failover and purposes of redundancy, site server 31 may also be coupled to server systems 46 and 52 for increased accessibility and reliability with cross cabling 61, 63, 64, 62 between dual or multiple switches and/or storage devices for multiple levels of communication redundancy and connectivity. Such connectivity generally provides at least dual levels of redundancy via each communication path regardless of path, device, and topology or communications protocol to provide a true no-single-point-of-failure solution. Additionally, each individual device has at least one separate path (not expressly shown) from site server 31 for management and recovery. Alternative arrangements of hardware components, both more complex and more simplified are anticipated and considered within the spirit and scope of the present disclosure.

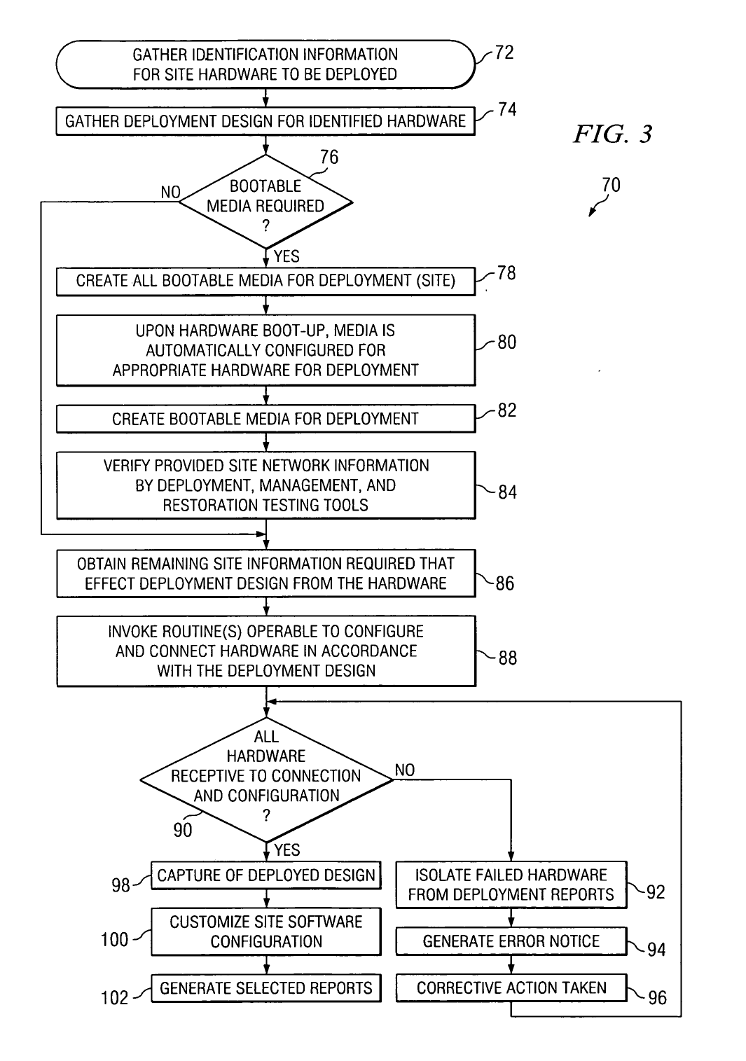

In operation, DMR site server 31 preferably translates a deployment design entered via hardware identification and deployment design interface 12 of FIG. 1 and configures or otherwise enables the components of complex standalone server, server-to-storage, SAN and/or standalone storage solution 30 via one or more communication paths 61, 62, 63, 64, 65, 66, 67 and 68 such that the deployment design may be effected. For example, DMR server 31 may inform switch 48 via communication link 61 that port “one” (1) of switch 48 is to be coupled to host bus adapter “A” of host and/or server 46. Similarly, DMR server 31 may communicate with storage device 56 via communication paths 64 and 68 that storage device 56 is to be coupled to a selected port of switch 54 as well as that selected drives and/or enclosures of storage device 56 may communicate only with site server 31. Additional detail regarding configuration of various hardware components to be included in a selected deployment of a standalone server, server-to-storage, SAN and/or standalone storage solution are discussed in greater detail below with respect to FIGS. 3 through 6.

Illustrated in FIG. 3 is a flow chart depicting one embodiment of a method for automating the deployment, management and restoration of a complex standalone server, server-to-storage, SAN and/or standalone storage solution according to teachings of the present disclosure, beginning with the gathering of pertinent information required to begin automation and suspending after the automation device is built and validates all gathered information. In general, method 70 of FIG. 3 preferably minimizes input required from a user and thereby maximizes the accuracy, reusability and recoverability of a complex standalone server, server-to-storage, SAN and/or standalone storage deployment.

In accordance with teachings of the present disclosure, method 70 for automating the deployment, management and restoration of complex standalone server, server-to-storage, SAN and/or standalone storage solutions begins at 72 with the gathering of identification information for hardware to be deployed at a selected site. As described above, identification information may be acquired via hardware identification and deployment design interface 12 of system 10.

The hardware identification information gathered may be varied in aspects of content as well as volume. For example, hardware identification information may include, without limitation, a hardware IP (Internet Protocol) address and serial number. Additional hardware identification information that may be gathered at 72 of method 70 includes, but is not limited to, device names, site codes, rack and slot locations, as well as other identifying information. Once identification information for selected hardware has been gathered, method 70 preferably proceeds to 74.

After identifying hardware to be included in a site deployment, method 70 preferably gathers a deployment design or arrangement of hardware at 74. Similar to the gathering of hardware identification information at 72, hardware identification and deployment design interface 12 of system 10 may be employed to gather a desired deployment design, according to teachings of the present disclosure. In a preferred embodiment, a deployment design gathered at 74 of method 70 preferably includes deployment design characteristic and configuration information ranging from the connectivity between devices and ports to software installation and configuration specialization. As such, myriad information concerning a complex information handling system deployment design may be sought at 74 of method 70.

In one embodiment, information gathered in association with a deployment design for identified hardware may include selection of which port on a given server connects to which port on a given storage device through which ports of one or more selected switches. Other information which may be collected in association with gathering information regarding a deployment design desired for identified hardware may include selection and identification of servers desired to act as file servers, email exchange servers, print servers, etc. Further, information regarding clustering servers and which servers are to be included into which clusters may also be collected at 74 of method 70.

Details regarding the deployment creation, partitioning, division, sharing, joining, configuration, LUN, volumes, groups, attachment, connection and or association, etc., of one or more storage devices may also be gathered at 74 of method 70. For example, logical unit number (LUN) and drive assignment information may be collected at 74. In addition, SAN or external storage device to switch connectivity information and external storage enclosure information may also be gathered.

Details regarding configuration of servers and their components includes, but is not limited to, a hardware personality profile including a hardware device's serial number, assigned name, site code, IP (Internet Protocol) assignment and assignment table information, as well as other information. Other automated decisions requested at 74 of method 70 may include whether to team multiple network interface cards (NIC) or other components included within a server. In one embodiment, software associated with the role a selected hardware device is to serve in the deployment design may also be chosen and configured at 74 of method 70. Additional hardware settings and configurations, as well as software applications, settings, and configurations, may be gathered at 74 of method 70 in accordance with teachings of the present disclosure.

Once the hardware for a deployment has been identified and the deployment design gathered at 72 and 74, respectively, method 70 preferably proceeds to 76. Depending on a variety of factors, one of which includes network security and integrity, the decision of whether to produce one or more bootable media devices may be determined and/or acted upon at 76. Otherwise, a decision can be made that no bootable media is required at 76.

In general, to accomplish deployment of a standalone server, server-to-storage, SAN and/or standalone storage solution, communication connectivity between the devices of the deployment is required. Methods for providing communication connectivity between hardware devices of a complex standalone server, server-to-storage, SAN and/or standalone storage solution include, but are not limited to, PXE (Preboot Execution Environment) boot, bootp servers and the use of bootable media adapted to assign static IP addresses.

If in a selected site deployment it is desirable to use static IP addresses to provide communication connectivity between the hardware to be deployed in a complex standalone server, server-to-storage, SAN and/or standalone storage solution, DMR engine 16 of system 10 preferably includes a capability to automatically generate bootable media devices required to facilitate connectivity. Accordingly, if at 76 it is determined that one or more bootable media devices are desired for use in the current deployment, method 70 preferably proceeds to 78 where bootable media devices for the selected hardware may be created. Once bootable media devices for selected hardware have been created at 78, method 70 preferably proceeds to 80, where selected hardware may be booted using bootable media before proceeding to 82.

At 82, after booting selected hardware using bootable media created at 80, one or more hardware verification procedures are preferably performed. Having communication capabilities between hardware devices to be included in a selected standalone server, server-to-storage, SAN and/or standalone storage deployment design, method 70, at 84, preferably provides for the verification of identification information provided and associated with site hardware. In one aspect, hardware verification performed at 84 may include a comparison between a user provided IP address and serial number for each hardware device, such as that provided at 72 of method 70, with an IP address and serial number read from each device being verified. Hardware identification information verification is preferably performed by DMR engine 16 of system 10 in one embodiment of the present disclosure. Additional hardware identification information may also be verified in accordance with teachings of the present disclosure.

In addition to verifying identification information provided at 72, method 70 may also perform a number of other hardware verification operations at 84. In a first aspect, method 70 at 84 may verify the presence and operability of one or more hardware devices to be included in a deployment. In a second aspect, method 70 at 84 may verify one or more cabling connections between hardware components such that hardware connectivity designated in the deployment design gathered at 74 may be properly implemented. Additional operations relating to verification of hardware identification, connections between hardware as well as other aspects of hardware presence and operability may be performed in accordance with teachings of the present disclosure.

Once one or more aspects of hardware identification information have been verified, the operability and presence of selected hardware components verified and/or cabling connections between selected hardware components verified, method 70 preferably proceeds to 86 where information remaining and required to effect a desired deployment design is preferably obtained from hardware devices of the deployment. In one aspect, teachings of the present disclosure provide for automated deployment, management and restoration of complex information handling systems including, but not limited to, a standalone server, server-to-storage, SAN and/or standalone storage solutions through the minimization of required user input and leveraging the connectivity of hardware components and logic included therein to obtain the information required to facilitate accurate and reliable deployment. Accordingly, in one embodiment, method 70 at 86 preferably automates the acquisition of worldwide name (WWN) identifiers for selected hardware, media access control (MAC) addresses for selected communication devices, as well as other information obtainable from the identified hardware and required to effect proper implementation of a deployment design. As mentioned above, obtaining information remaining and required to effect a desired deployment design from identified hardware may be implemented in one or more aspects or utilities of DMR engine 16 of system 10.

Once the remaining information needed to effect or implement a desired deployment design has been gathered and obtained, such as at 72 and 86, method 70 preferably proceeds to 88. At 88, one or more routines or scripts operable to configure and connect identified hardware in accordance with a desired deployment design may be initiated, invoked or executed.

In one aspect, basic server provisioning/configuration utilities 18 and/or complementary hardware provisioning and configuration utilities 20 of DMR engine 16 preferably contain one or more scripts operable to effect a desired complex standalone server, server-to-storage, SAN and/or standalone storage deployment design. Accordingly, in one aspect, the information necessary to configure one or more servers to be included in a deployment design may be passed off to basic server provisioning/configuration utilities 18 while complementary hardware provisioning /configuration utilities 20 may receive information pertaining to advanced server configuration, server to switch communication and configuration, as well as switch to storage device communication and configuration. Alternative task assignments among components included in DMR engine 16 are contemplated within the spirit and scope of the present disclosure.

In one embodiment, scripts or routines executed or invoked at 88 are preferably operable to cooperate with hardware based command line interfaces to effect configuration. In an alternate embodiment, unique code may be included permitting DMR engine 16 to create connections, set configurations, as well as perform other hardware arrangement or set-up tasks. As such, in a complex standalone server, server-to-storage, SAN and/or standalone storage deployment design, method 70 at 88 is preferably operable to configure communication and configuration between at least one server and at least one switch as well as between a switch and at least one storage area network or external storage device. In addition, method 70 at 88 is preferably further operable to create communication and configuration redundancies included in a desired complex standalone server, server-to-storage, SAN and/or standalone storage or storage area network deployment design.

In part to ensure effective implementation of a deployment design, method 70 at 90 preferably monitors hardware being configured and connected in accordance with the deployment design to ensure that the hardware is receptive to connection and configuration. If at 90 it is determined that one or more hardware devices is failing connection or proper configuration, method 70 preferably proceeds to 92 where the failing hardware may be isolated. Upon isolating the failing hardware at 92, method 70 preferably proceeds to 94, where one or more error notices may be generated. For example, one or more display devices coupled to DMR server 31 of FIG. 2 or other hardware component of an IHS solution being configured may display an error notice identifying a hardware component failing connection or configuration. Alternative forms of notifying a user as to hardware failing proper connection or configuration are contemplated within the spirit and scope of the present disclosure and may include, but are not limited to, one or more flashing LEDs (light emitting diodes) associated with the failing hardware and generating one or more beep codes indicative of failing hardware or an identified hardware problem.

After generating an error notice at 92, method 70 preferably proceeds to 96, where corrective action may be taken and/or received from the DMR server. Following corrective action at 96, method 70 preferably returns to 90 for subsequent verification that all hardware selected for inclusion in a desired deployment design is receptive to proper connection and configuration. Alternative implementations of identifying, isolating and repairing non-responsive or failing hardware are contemplated in accordance with teachings of the present disclosure. Despite determining that one or more hardware devices may not be receptive to proper connection and configuration at 90, method 70 preferably continues with configuration of the receptive hardware components of the desired deployment design while substantially simultaneously performing the isolating, generating and corrective actions at steps 92, 94 and 96, respectively.

Upon completion of the implementation of the desired deployment design, method 70 preferably performs a deployment design capture of the deployed solution at 98. In one aspect, the deployment design capture performed at 98 of method 70 preferably records or otherwise maintains myriad connection and configuration settings created or established in accordance with implementation of the deployment design. In another aspect, the deployment design capture preferably performed at 98 may also be used for rapid restoration of one or more failing components of an implemented deployment design. In a further aspect, the deployment design capture preferably performed at step 98 of method 70 may be used in one or more respects to manage a complex standalone server, server-to-storage, SAN and/or standalone storage solutions.

As mentioned above, a DMR utility incorporating teachings of the present disclosure preferably includes an ability to configure and implement, in accordance with a desired deployment design, one or more hardware components of a complex standalone server, server-to-storage, SAN and/or standalone storage deployment design, as well as one or more software components of the desired deployment design. As such, at 100 of method 70, customized software configuration may be effected in accordance with deployment design specifications, such as those gathered at 74.

Following customization of one or more software configurations at 100, method 70 preferably proceeds to 102. At 102, one or more reports regarding the implemented deployment design may be generated. For example, one or more reports identifying various hardware devices included in the deployment, configuration information associated with hardware devices included in the deployment, connections between hardware devices of the deployment, as well as other aspects of the deployment, may be generated. Additional reports that may be created at 102 of method 70 include, but are not limited to, graphical maps depicting placement and connection of hardware components of the deployment design, one or more hardware utilization reports and projected capacity reports for the deployment design. Various additional reports may be generated at 102 of method 70 without departing from the spirit and scope of teachings of the present disclosure.

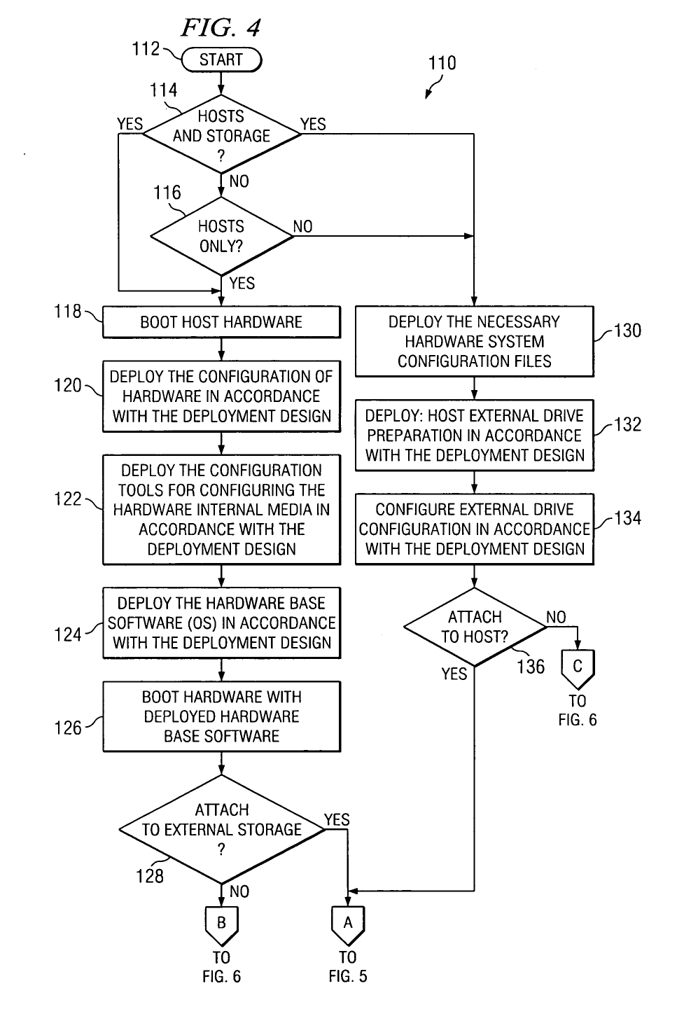

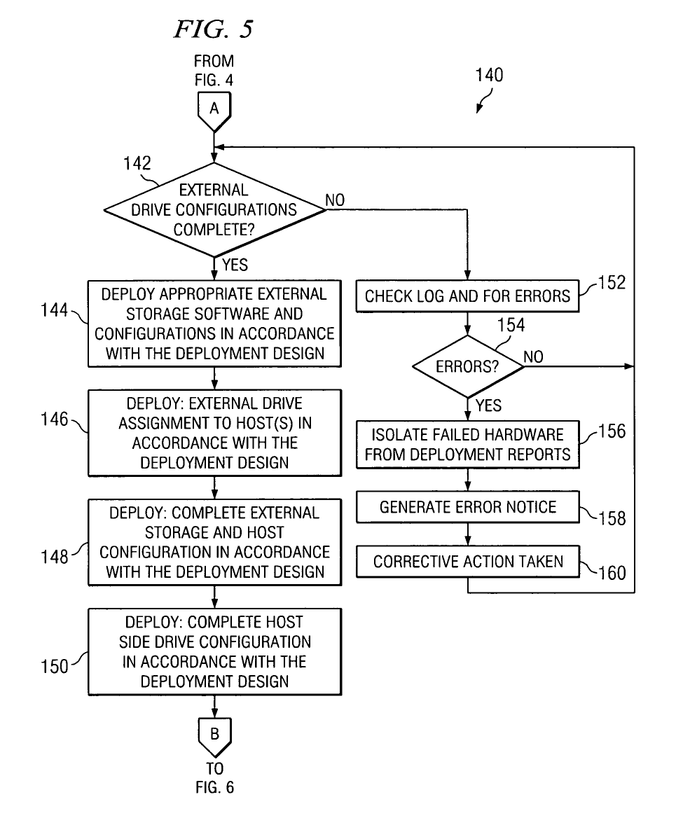

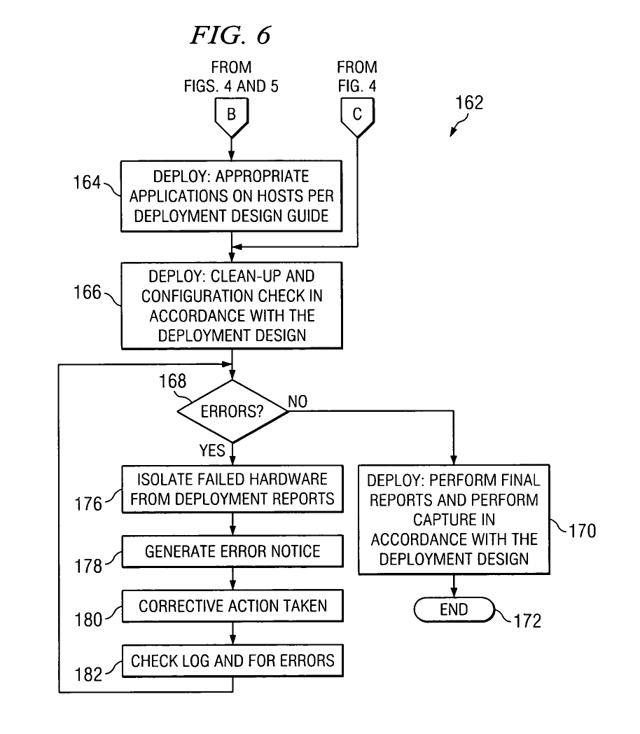

Referring now to FIG. 4, a methodology for automatic deployment, management and restoration of one or more servers and one or more external storage products in a standalone server, server-to-storage, SAN and/or standalone storage solution is shown, according to teachings of the present disclosure. Upon beginning at 112, method 110 preferably proceeds to 114 where one or more servers or storage devices to be deployed in accordance with teachings of the present disclosure are preferably identified. At 116, the devices to be displayed are preferably interrogated and polled and the bootable devices preferably proceed to 118 where they may be booted. As mentioned above, booting may occur, at least, via the use of boot media in a static IP address scenario, PXE (Preboot Execution Environment) boot or using a bootp (Bootstrap Protocol) server. Upon booting one or more selected servers, method 110 preferably proceeds to 118 where the booted servers may be deployed in accordance with specified hardware requirements recognized through system firmware, BIOS-related chipsets and in accordance with the deployment design. A quality and version check may be performed on all hardware, RAID (redundant array of inexpensive disks) adapters, controllers and/or devices' firmware/BIOS/drivers to determine whether an upgrade is required or suggested before beginning. Following the version check, multiple communications adapters like Ethernet NICs (network interface cards or controllers) may be enabled, disabled or deployed.

Upon deploying, at 120, the deployment design configuration of the hardware for one or more servers, method 110 preferably proceeds to 122 where deployment hardware and software tools are preferably used to configure any and all forms of internal media. Appropriate application tools are preferably used to prepare the media for data availability and usage.

Continuing, method 110 at 124 preferably completes a system base software build by deploying a required and/or specified software operating system (OS) on existing and previously configured hardware. In one embodiment, a base software build may include a base OS image having selected components of the OS preconfigured. Base image software for each server may be included and based upon the type and role of server in the deployment design, e.g., file, print, Microsoft Exchange, etc. Following the deployment of a base OS, a server may be rebooted, if necessary.

Following operation(s) at 124, method 110, at 126, preferably provides for the initialization and boot of the system OS. Following initialization and boot of 126, a decision may be made as to whether one or more of the hardware systems configured is to be coupled to an external storage device. If at 128 it is determined that one or more systems is to be coupled to external storage, method 110 preferably proceeds to 142 of FIG. 5. Alternatively, if at 128 it is determined that one or more systems are not to be coupled to external storage, method 110 preferably proceeds to 164 of FIG. 6.

In another aspect of method 110, after beginning at 112, a decision is preferably made as to whether the connected devices are servers or storage devices before deciding what action needs to be performed on them at 114. Assuming the connected devices are not server systems, method 110 preferably proceeds to 130 where the necessary hardware system configuration files, information, software and or any form of data required to complete the pre-boot initialization process for each storage device may be deployed.

Following operations at 130, method 110 preferably proceeds to 132 where all external media devices capable of containing data may be prepared in accordance with the deployment design. The media format alignment and preparation may be different and depend on the manufacturer of a selected storage device. Following the external device preparation at 136, method 110 may proceed to 134 where byte-by-byte level configuration, partitioning, division, segmentation, container, individual or group sub-level logical changes necessary and required to make various external storage devices and media available and ready for use may be effected. After one or more storage devices have been prepared in accordance with the deployment design, method 110, at 136, preferably provides for a decision as to whether any of the external storage devices will be attached to one, many or no servers. If the external storage device will not be coupled to one or more servers, method 110 preferably proceeds to 166 of FIG. 6, otherwise the attachment with servers it proceeds to 142 of FIG. 5.

Referring now to FIG. 5, a methodology for automatic deployment, management and restoration of one or more servers and or one or more storage devices in either a server-to-storage, SAN and/or standalone storage device solution is shown, according to teachings of the present disclosure. Following operations at 128 of FIG. 4, method 140 of FIG. 5, preferably proceeds to 142 where one or more server-to-storage and or one or more storage devices to be deployed in accordance with teachings of the present disclosure are checked for consistency, configuration accuracy and completion in accordance with a defined configuration request. Method 140 then preferably proceeds to 144 where selected external storage software may be deployed and configured in accordance with the deployment design. Such software could aid and assist in RAID configuration, interpretation between GUI software and hardware interface, load-balancing, failover, migration, replication, etc.

At 146, configuration of external storage devices preferably begins by logically partitioning, dividing, grouping elements or components created by leveraging the external storage software deployed in 144. An alternate embodiment extracts the deployment design and automatically configures any switches, ports, redundant paths for communication before zoning—assuming a switched network is in place or desired for storage devices.

At 148, the external storage device configuration is preferably physically matched with the server configuration and if any partitioning, division, sharing, joining, matching of data groups or elements is required by the use of LUNs, volumes, groups, maps, data paths or tables in conjunction with the storage software deployed in 144 then such preferably proceeds. Additionally, server hardware is preferably software initiated for logical attachment to a specified storage device via the OS. Upon entering 150 of method 140, the server for server-to-storage, SAN configuration is preferably completed with all storage applications and ready to use in accordance with teachings of the present disclosure.

Otherwise, a negative response at 142 would result in a double checking of error logs in 152. If errors exist at 154, then a further investigation would ensure a failure would be isolated at 156 from existing deployment design reports. Further error notices may be generated at 158 and corrective action taken at 160 to fix and complete the failure before returning the process to 142 for another double check of the external device configuration's status for completion of method 140.

Method 162 of FIG. 6 preferably beginning at 164 to deploy remaining non-storage related applications required to complete server mission as provided by deployment design. One or more customer requested or required applications may be installed on selected hardware to be included in the desired deployment design. For example, a SNMP (simple network management protocol) update, a DNS (domain name service) update, as well as one or more applications associated with teaming network interface controllers (NIC) could simultaneously take place. Additional applications may also be installed on one or more components to be included in the desired site deployment in accordance with teachings of the present disclosure.

At 166, all devices are preferably doubled checked before being cleaned and scrubbed for OS and configuration discrepancies in accordance with the deployment design. In a further aspect, method 110 of FIG. 4 may enter method 162 of FIG. 6 where the standalone storage device process connects and terminates into 166 for successful deployment configuration cleanup.

In a methodology for automatic deployment, management and restoration of one or more servers and or one or more storage devices in either a server-to-storage, SAN and/or standalone storage device solution as shown, according to teachings of the present disclosure, method 162 at 168 preferably performs consistency checks on the deployment cleanup and configuration check performed at 166. Clean bills of health and no errors assist DMR in a final deployment report, at 170, and a full and complete deployment design capture before a successful process completion 172. However non-clean bills of health and error generation identified at 168 will preferably force error isolation from deployment design reports at 176. As a continuance, operations preferably performed at 178 will generate error notices and permit corrective action to mitigate and correct the errors at 180. At 182, errors are preferably double checked against the logs before attempting to re-run without errors at 168.

Although the disclosed embodiments have been described in detail, it should be understood that various changes, substitutions and alterations can be made to the embodiments without departing from their spirit and scope.

1. Software for automating implementation of a complex information handling system (IHS) hardware deployment, the software embodied in computer readable media and when executed operable to:
collect information identifying IHS hardware for a complex IHS hardware deployment;
discover additional information required to implement the complex IHS hardware deployment; and
initiate at least one routine operable to configure the IHS hardware in accordance with the collected and discovered information such that implementation of the complex IHS hardware deployment may be effected.

2. The software of claim 1, further operable to gather details concerning configuration of the IHS hardware deployment.

3. The software of claim 2, further operable to limit entry of configuration details in accordance with a rules database, the rules database operable to verify operability of configuration selections based on the hardware identified for inclusion in the deployment.

4. The software of claim 1, further operable to collect IHS hardware identification information including at least an Internet Protocol address and a serial number for each IHS hardware component.

5. The software of claim 1, further operable to verify at least a portion of the IHS hardware identification information before initiating one or more routines operable to effect implementation of the IHS hardware deployment.

6. The software of claim 1, further operable to verify connectivity between a plurality of IHS hardware components to be included in the IHS hardware deployment.

7. The software of claim 1, further operable to determine whether cables connecting selected hardware are connected in accordance with a detailed port-to-port IHS hardware deployment description.

8. The software of claim 1, further operable to perform a deployment design capture upon completion of the IHS hardware deployment.

9. The software of claim 1, further operable to collect information identifying one or more servers, switches and storage area networks to be deployed in accordance with the IHS hardware deployment.

10. The software of claim 1, further operable to generate one or more reports concerning the IHS hardware deployment upon completion.

11. The software of claim 1, further operable to selectively create bootable media operable to provide secure communications capabilities with at least one server computer to be included in the IHS hardware deployment.

12. The software of claim 1, further operable to isolate hardware failing to respond to the one or more routines operable to effect implementation of the IHS hardware deployment.

13. The software of claim 1, further operable to issue hardware compliant instructions to effect implementation of configurations and connections required to realize the IHS hardware deployment.

14. A method for deploying a complex information handling system solution, comprising:
gathering information identifying hardware to be included in the complex information solution;
gathering information describing the complex information solution to be deployed; and
providing the hardware identification information and the complex information solution description information to at least one program of instructions operable to effect realization of the complex information solution through method steps including verifying connectivity between selected identified hardware, discovering from the identified hardware information required to implement the complex information solution and configuring selected identified hardware in accordance with the hardware identification information, the complex information arrangement description and the discovered information.

15. The method of claim 14, further comprising comparing user provided hardware identification information with hardware identification information gathered from the hardware by the program of instructions.

16. The method of claim 14, further comprising generating at least one report indicative of a completed complex information handling system solution via the program of instructions.

17. The method of claim 14, further comprising determining, via the program of instructions, whether cabling connections within the complex information handling system solution are connected such that implementation of the complex information handling system solution description may be realized.

18. The method of claim 14, further comprising verifying, via the program of instructions, feasibility of the complex information handling system solution description with a rules database based on a plurality of technical considerations associated with the hardware identified for inclusion in the complex information handling system solution.

19. The method of claim 14, further comprising creating, via the program of instructions, bootable media operable to enable communication with at least one server to be deployed in the complex information handling system solution.

20. The method of claim 14, further comprising:
identifying IHS hardware resistant to configuration in accordance with the complex information handling system solution description;
isolating the configuration resistant IHS hardware; and
generating a notification of one or more errors realized in attempting to configure the resistant hardware via the program of instructions.

21. The method of claim 14, further comprising invoking one or more scripts included in the program of instructions operable to connect a server to a storage area network through a switch.

22. The method of claim 14, further comprising capturing a restoration image of the complex information handling system solution upon configuration completion via the program of instructions.

23. The method of claim 14, further comprising configuring one or more software preferences selected for inclusion on the complex information handling system solution via the program of instructions.

24. An information handling system for use in deploying, managing and restoring complex hardware, comprising:
at least one processor;
memory operably associated with the processor; and
a program of instructions storable in the memory and executable by the processor, the program of instructions operable to receive information identifying complex hardware to be configured and a configuration description for the hardware deployment, obtain from the hardware unique information required to implement the described hardware configuration and execute at least one script configured to effect one or more settings in the hardware such that the hardware configuration description may be realized.

25. The information handling system of claim 24, further comprising the program of instructions operable to verify that a provided hardware Internet Protocol address and a provided hardware serial number match an Internet Protocol address and a serial number stored by the hardware and read by the program of instructions.

26. The information handling system of claim 24, further comprising the program of instructions operable to verify availability of the hardware to be configured.

27. The information handling system of claim 26, further comprising the program of instructions operable to determine whether cabling connections between hardware components are connected such that the described configuration may be achieved.

28. The information handling system of claim 24, further comprising the program of instructions operable to obtain at least a world wide name, a media access control address and host bus adapter identification from selected hardware.

29. The information handling system of claim 24, further comprising the program of instructions operable to interface with a hardware configuration rules database, the hardware configuration rules database operable to constrain selection of hardware configuration descriptions based on at least one limitation associated with the identified hardware.

30. The information handling system of claim 24, further comprising the program of instructions operable to selectively create bootable media operable to permit communication between a plurality of hardware devices to be included in the hardware deployment.

31. The information handling system of claim 24, further comprising the program of instructions operable to isolate hardware failing one or more configuration tests and complete configuration of remaining hardware.

32. The information handling system of claim 24, further comprising the program of instructions operable to execute one or more scripts adapted to create a connection from a selected server to a selected port of a switch and the switch to a storage area network.

33. The information handling system of claim 24, further comprising the program of instructions operable to create a hardware deployment recovery image upon implementation of the hardware configuration description.

34. The information handling system of claim 24, further comprising the program of instructions operable to generate one or more reports concerning the realized hardware configuration in response to user selection.
